(19) United States
(12) Patent Application Publication
(10) Pub. No.: US 2024/0074356 A1
(43) Pub. Date: Mar. 7, 2024

(54) Method and control device for operating an agricultural harvester and agricultural harvester

(71) Applicant: CLAAS Saulgau GmbH, Bad Saulgau (DE)

(72) Inventors: Michael Fugunt, Bad Wurzach (DE); Philipp Bistritz, Singen (DE); Werner Schleifer, Mengen (DE); Markus Neuhauser, Wain (DE); Martin Reinhardt, Eningen (DE)

(21) Appl. No.: 18/460,781

(22) Filed: Sep. 5, 2023

(30) Foreign Application Priority Data
Sep. 5, 2022 (DE) DE 102022122350.7

(51) Int. Cl. A01F 15/08; A01D 43/06

(52) U.S. Cl. CPC A01F 15/0825; A01D 43/06

(57) ABSTRACT

Method for operating an agricultural harvester (1), wherein the agricultural harvester (1) has at least one mowing unit (3, 4, 5), the respective mowing unit (3, 4, 5) has mowing elements (6) for mowing crop and a swathing device (7, 8) for discharging the mowed crop in the form of at least one swath (9, 10, 11), a density of the crop and/or a moisture content of the crop is determined, and wherein a width of the at least one swath (9, 10, 11) is adjusted automatically, depending on the determined density of the crop and/or the determined moisture content of the crop. FIG. 1

The invention relates to a method and a control device for operating an agricultural harvester and an agricultural harvester.

Agricultural harvesters with at least one mowing unit are known from practice. Thus, an agricultural harvester can have a carrier vehicle and at least one mowing unit coupled to the carrier vehicle. The respective mowing unit has mowing elements for mowing the crop and a swathing device for discharging the mowed crop in the form of at least one swath.

DE 10 2005 051 543 A1 discloses an agricultural harvester having a carrier vehicle and having three mowing units coupled to the carrier vehicle. The mowing units can deposit or discharge the cut crop in the form of swaths.

DE 88 12 645 U1 discloses a mowing unit designed as a front mowing unit of an agricultural harvester. The cut or mowed crop can be discharged in the form of a swath via swathing disks or other swathing formers such as bar screens, swath shields or driven belt conveyors.

DE 20 2019 001 404 U1 proposes calculating a conditioning intensity for agricultural fruits on the basis of remotely sensed data. Thus, it is proposed to calculate the conditioning intensity of conditioning methods such as bending, cutting, crushing and supplying additives and to regulate corresponding processing elements on that basis.

Starting from this point, the present invention is based on the object of devising a novel type of method and control device for operating an agricultural harvester and an agricultural harvester having such a control system.

This object is achieved by a method for operating an agricultural harvester according to patent claim 1.

According to the invention, in an agricultural harvester having at least one mowing unit, a density of the crop and/or a moisture content of the crop is determined, wherein a width of the at least one swath which is discharged by the at least one mowing unit is adjusted automatically, depending on the determined density of the crop and/or the determined moisture content of the crop.

With the invention here, it is proposed for the first time to automatically adjust the width of at least one swath of mowed crop deposited by at least one mowing unit, depending on the determined density of the crop and/or the determined moisture content of the crop.

The invention is based on the finding that the drying process of cut crop combined into at least one swath largely depends both on the density of the crop and also on the moisture content of the crop. As a result of the automatic adjustment and therefore displacement of the width of the at least one discharged swath, depending on the density and/or the moisture content of the crop, the drying process can be influenced automatically in order to ensure a homogenous moisture content in the crop, in particular when the crop is, for example, intended to be picked up by a loading wagon.

Preferably, the width of the at least one swath is adjusted to be larger or wider the higher or greater the determined density of the crop is. This adjustment of the width of the crop, depending on the determined density, is preferably carried out on the basis of a characteristic curve or characteristic map.

Preferably, the width of the at least one swath is adjusted to be larger or wider the higher or greater the determined moisture content of the crop is. This adjustment of the width of the at least one swath, depending on the determined moisture content of the crop, is likewise preferably carried out on the basis of a characteristic curve or characteristic map.

Preferably, the density of the crop and/or the moisture content of the crop is determined with the aid of at least one sensor of the agricultural harvester. Alternatively or else additionally, the density of the crop and/or the moisture content of the crop can be determined on the basis of remotely sensed data such as satellite images and/or drone images and/or yield maps and/or weather data. If the density and/or moisture content of the crop is determined with the aid of at least one sensor of the agricultural harvester, then the width of the at least one swath can be adjusted automatically dynamically. In addition, depending on drone images which are obtained with the aid of at least one drone which flies over a surface to be processed, the width of the at least one swath can be adjusted automatically dynamically. Drone images can be combined with yield maps and weather data.

Preferably, the width of the at least one swath is adjusted on the basis of a characteristic curve or characteristic map, depending on the determined density and/or the determined moisture content. When the width of the respective swath is adjusted on the basis of a characteristic curve or characteristic map, depending on the determined density and the determined moisture content, the determination of the width of the swath is particularly simply and reliably possible on the basis of a stored, empirically determined characteristic map or a corresponding characteristic curve.

The control device is defined in patent claim 7.

The agricultural harvester is defined in patent claim 9.

Preferred developments of the invention can be gathered from the sub-claims and the following description.

Exemplary embodiments of the invention will be explained in more detail by using the drawing, without being restricted thereto. In the drawing:

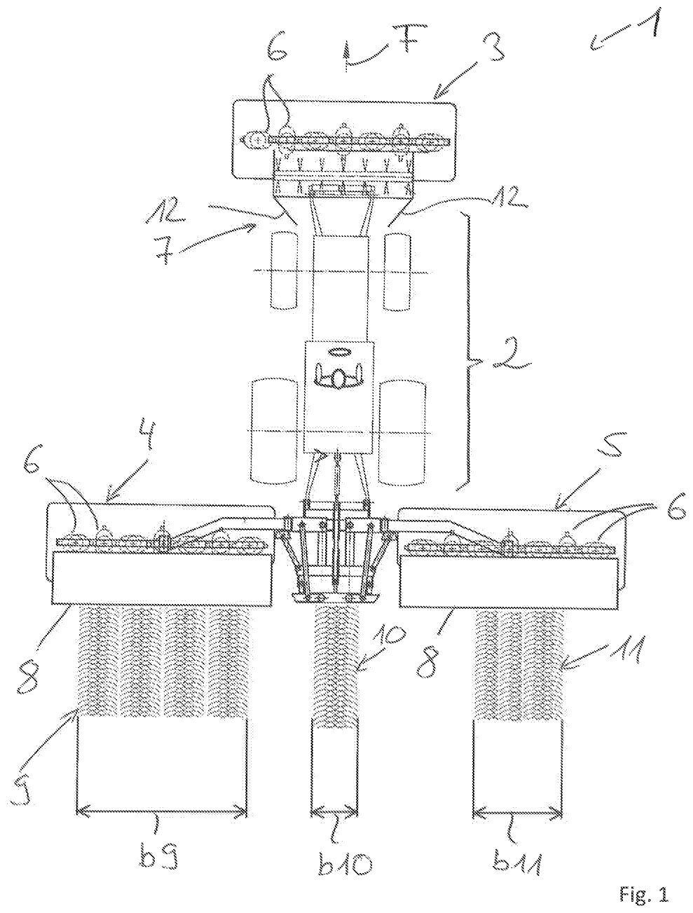

FIG. 1 shows a plan view of an agricultural harvester.

FIG. 1 shows an agricultural harvester 1, which has a carrier vehicle 2 and a plurality of mowing units 3, 4 and 5 mounted on the carrier vehicle 2. The mowing unit 3 in FIG. 1 is a front mowing unit, the mowing units 4 and 5 are rear mowing units.

Each of the mowing units 3, 4 and 5 has mowing elements 6 for mowing a crop. The mowing elements 6 are also designated as cutting elements.

Each of the mowing units 3, 4 and 5 further has a swathing device 7, 8. Mowed or cut crop can be deposited in the form of at least one swath via the swathing devices 7, 8. Thus, FIG. 1 shows that each mowing unit 3, 4, 5 discharges a respective swath 9, 10, 11 of cut crop.

Thus, the swathing device 7 discharges the crop that is mowed or cut by the front mowing unit 3 in the form of a central swath 10. The swathing device 7 of the front mowing unit 3 has, for example, swath shields 12. The width b10 of the central swath 10 can be adjusted via the alignment of the swath shields 12.

The two rear mowing units 4, 5 each discharge a swath 9, 11, specifically via their swathing device 8. The respective rear mowing unit 4, 5 can also comprise swath shields and/or a transverse conveying device as a swathing device 8. In FIG. 1, the rear mowing unit 4 discharges the swath 9 and the rear mowing unit 5 discharges the swath 11, specifically with the corresponding widths b9 and b11.

The direction of movement of the agricultural harvester of FIG. 1 is identified in FIG. 1 by the arrow F.

In the sense of the present invention, the density of the crop and/or the moisture content of the crop is determined. Depending on the determined density of the crop and/or the determined moisture content of the crop, the width of the at least one swath is adjusted automatically. Thus, it is possible to adjust the swath width b9, b10 and b11 automatically individually for each of the three swaths 9, 10 and 11 shown in FIG. 1.

The width b9, b10, b11 of the at least one swath 9, 10, 11 is adjusted to be greater or wider the higher or greater the determined density of the crop is.

Furthermore, the width b9, b10, b11 of the at least one swath 9, 10, 11 is set to be greater or wider, the higher or greater the determined moisture content of the crop is.

The invention is based on the finding that the drying process of the crop that is mowed and combined to form at least one swath depends on the density and the moisture content of the same.

As a result of the automatic adjustment of the swath width, depending on the density and/or the moisture content of the crop, the drying process can be influenced actively in order to provide a homogenous moisture content in the crop when the crop is, for example, intended to be picked up from the surface or ground by a loading wagon.

The density of the crop and/or the moisture content of the crop can be determined with the aid of at least one sensor of the agricultural harvester.

Thus, in the area of each mowing unit 3, 4 and 5, an individual sensor for determining the moisture content and/or an individual sensor for determining the density can be installed, in order to determine the density and/or the moisture content individually for each mowing unit 3, 4, 5 and thus to adjust the width b9, b10, b11 of the respective swath 9, 10, 11 individually for each mowing unit 3, 4, 5. Moisture content sensors are sufficiently well known. A sensor for determining the density can be a camera.

It is also possible to provide a sensor for determining the density and/or the moisture content of the crop only on one mowing unit 3, 4, 5 and then, on this basis, to determine the width b9, b10, b11 of the respective swath 9, 10, 11 for all the mowing units 3, 4, 5.

Alternatively or additionally to determining the density and/or the moisture content of the crop with the aid of at least one sensor, it is possible to determine the density of the crop and/or the moisture content of the crop on the basis of remotely sensed data such as satellite images and/or drone images and/or yield maps and/or weather data.

Thus, for example a drone flying over a surface to be processed can determine images which are then used to determine the density of the crop and/or the moisture content of the crop, specifically preferably combined with yield maps and/or weather data. In addition, in this way the density and/or the moisture content of the crop can thus be determined highly accurately, in order on this basis to adjust the width b9, b10, b11 of the respective swath 9, 10, 11 automatically.

The width of the at least one swath is preferably adjusted on the basis of a characteristic curve or characteristic map, depending on the determined density and/or determined moisture content.

Thus, a characteristic curve or else a characteristic map can be stored in a control device, in order to determine a target width of the at least one swath 9, 10, 11 automatically on the basis of the density and/or the moisture content of the crop. The control device can activate the swathing device 7, 8 of the respective mowing unit 3, 4, 5 automatically on the basis of the determined target width of the respective swath 9, 10, 11, in order to adjust the current width of the respective swath automatically, specifically to match it to the target width.

The invention also relates to a control device of an agricultural harvester which is set up to carry out the method according to the invention automatically. This control device is preferably an electronic control device which has hardware means and software means for carrying out the method according to the invention.

The hardware means include data interfaces in order to exchange data automatically with the assemblies involved in carrying out the method according to the invention.

Thus, it is possible that the control device receives measured variables from at least one sensor via at least one data interface, on the basis of which measured variables the control device then determines the density of the crop and/or the moisture content of the same. Via a further data interface, the control device can automatically output the swath width determined by the same, in particular in order to adjust the width of the swath at the respective mowing units 3, 4, 5 automatically, for which purpose the control device outputs appropriate manipulated variables to the swathing device 7, 8 of the respective mowing unit 3, 4, 5 via a respective data interface.

The hardware means further include a memory for data storage and a processor for data processing. For example, a characteristic map or a characteristic curve can be stored in the memory, on the basis of which the width of the respective swath is determined and adjusted automatically, depending on the determined density and/or depending on the determined moisture content.

The software means include program modules which are implemented in the control device to carry out the method according to the invention.

The control device is set up to adjust the width of the at least one swath automatically, depending on the determined density and/or the determined moisture content of the crop. Furthermore, the control device is preferably set up to automatically determine the density of the crop and/or the moisture content of the crop.

By using the invention, depending on the density and/or the moisture content of the crop, the width of swaths 9, 10, 11 on an agricultural harvester having mowing units 3, 4, 5 can be adjusted automatically, in order to ensure a homogenous moisture content in the crop after a drying process. The adjustment of the swathing devices 7, 8 of the mowing units 3, 4, 5 is preferably carried out automatically, in particular by means of electrohydraulic adjustment or mechanical adjustment of the respective swathing device 7, 8. The swath width can be adapted automatically, depending on the density and/or the moisture content.

Furthermore, the invention relates to an agricultural harvester having at least one mowing unit 3, 4, 5 and a control device according to the invention.

It is possible to provide a separate control device in the area of each mowing unit 3, 4, 5. In a mowing unit combination comprising a plurality of mowing units 3, 4, 5—for example comprising a front mowing unit and one or more rear mowing units—a common control device could alternatively be provided for all the mowing units 3, 4, 5. This common control device could preferably be arranged on an attachment device of the rear mowing units.

However, it would also be possible to arrange a common control device on the carrier vehicle 2.

### LIST OF DESIGNATIONS

1 Agricultural harvester
2 Carrier vehicle
3 Mowing unit
4 Mowing unit
5 Mowing unit
6 Mowing element
7 Swathing device
8 Swathing device
9 Swath
10 Swath
11 Swath

1. A method for operating an agricultural harvester (1),
wherein the agricultural harvester (1) has at least one mowing unit (3, 4, 5),
wherein the respective mowing unit (3, 4, 5) has mowing elements (6) for mowing crop and a swathing device (7, 8) for discharging the mowed crop in the form of at least one swath (9, 10, 11),
characterized in that
a density of the crop and/or a moisture content of the crop is determined,
a width of the at least one swath (9, 10, 11) is adjusted automatically, depending on the determined density of the crop and/or the determined moisture content of the crop.

2. The method according to claim 1, characterized in that the width of the at least one swath (9, 10, 11) is adjusted to be larger or wider the higher or greater the determined density of the crop is.

3. The method according to claim 1, characterized in that the width of the at least one swath (9, 10, 11) is adjusted to be larger or wider the higher or greater the determined moisture content of the crop is.

4. The method according to claim 1, characterized in that the density of the crop and/or the moisture content of the crop is determined with the aid of at least one sensor of the agricultural harvester (1).

5. The method according to claim 1, characterized in that the density of the crop and/or the moisture content of the crop is determined on the basis of remotely sensed data such as satellite images and/or drone images and/or yield maps and/or weather data.

6. The method according to claim 1, characterized in that the width of the at least one swath (9, 10, 11) is adjusted on the basis of a characteristic curve or characteristic map, depending on the determined density and/or the determined moisture content.

7. A control device of an agricultural harvester (1),
wherein the agricultural harvester (1) has at least one mowing unit (3, 4, 5),
wherein the respective mowing unit (3, 4, 5) has mowing elements (6) for mowing crop and a swathing device (7, 8) for discharging the mowed crop in the form of at least one swath (9, 10, 11),
characterized in that
the control device is set up to automatically adjust a width of the at least one swath (9, 10, 11), depending on a determined density of the crop and/or a determined moisture content of the crop.

8. A control device according to claim 7, characterized in that the control device is set up to automatically carry out the method according to one of claims 1 to 6.

9. An agricultural harvester (1) having at least one mowing unit (3, 4, 5) and having a control device according to claim 7.
